(19) United States
(12) Patent Application Publication
(10) Pub. No.: US 2009/0292987 A1
(43) Pub. Date: Nov. 26, 2009

(54) FORMATTING SELECTED CONTENT OF AN ELECTRONIC DOCUMENT BASED ON ANALYZED FORMATTING

(75) Inventor: Michael Whitney Sorenson, CAMBRIDGE, MA (US)

Correspondence Address: PATENTS ON DEMAND, P.A. - IBM CAM, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/125,775

(22) Filed: May 22, 2008

(51) Int. Cl. G06F 17/00

(52) U.S. Cl. 715/255

(57) ABSTRACT

One aspect of the present invention can include a method, computer program product, system, and/or device for formatting content of an electronic document. In the aspect, pending content from a source document can be identified that is to be inserted into a target document. An insertion point in the target document can be identified. Format settings of pre-existing content of the target electronic document can be analyzed in a range about the insertion point. Predominant format settings for the pre-existing content in the range can be determined. The determined predominant format settings can be applied to the pending content to generate a version of the pending content formatted in accordance with the determined predominant format settings. The version pending content conforming to the predominant format of the target can then be added to the target document at the insertion point.

### BACKGROUND OF THE INVENTION

The present invention relates to the field of electronic document manipulations and, more particularly, to formatting content of an electronic document based upon analyzed formatting.

Text editing or word processing functionality has become increasingly complex giving users a large range of options for editing and presenting content in electronic documents. Formatting options include, for example, tab positioning, font size, font color, font type, line spacing, paragraph spacing, column formatting, automatic numbering options, bullets and formatting, highlighting, text case, background coloration, dynamically indexed page numbers, and the like. Many users are somewhat confused with more complex formatting options, which can significantly change the presentation of a document. For example, the application of different style sheets or templates to different sections of a document is often beyond the comprehension of a typical user. The fact that most formatting special characters and triggers are by default “hidden” by word processing applications, encourages most casual users to ignore format-effecting special characters contained within an electronic document or to treat these format-effecting special characters as application controlled characteristics that are unable to be directly manipulated in a straight forward manner.

When formatting options of an electronic document are “well behaved”, users are often very happy with the results. Unfortunately, complex intra-document formatting sometimes causes a document to behave mysteriously, at least from the perspective of a user. When this occurs, users can quickly become frustrated when all paragraph numbering shifts unexpectedly, when all entered text is by default in the wrong case, font, size, or color, when tabs produce different spacing than expected, when entered text suddenly appears in multiple columns, and when other idiosyncratic behavior occurs.

One common situation that involves format peculiarities occurs when content from a source document is inserted into a target document. This can occur during cut-and-paste operations, during document merges, and the like. Problems also occur when multiple users co-author a document, since co-authors often originally use different formats for their portion of the ultimate document. Additionally, many situations exist where a stored document is re-used as a template for new content, where an editor is often unfamiliar or confused by intra-document formatting options of an original document. These intra-document formatting issues tend to increase over time, as subsequent revisions often contain “hidden” formatting that is ignored as it doesn't effect an end presentation of a current document.

Different approaches have been taken to assist with content insertion operations, each having substantial shortcomings. In one approach, formatting options of the source document are copied along with the source content and directly inserted into the target document. These formatting options often conflict with previous formatting of the target document. Another approach is to only copy semantic content from the source and to ignore its formatting (i.e., copy text and ignore special characters relating to formatting that text). This results in non-formatted content being inserted into the target document. Still another approach is to apply “current” target formatting to the inserted content, as if the content were being typed into the target document from a keyboard or otherwise entered manually. The current formatting, however, is often not representative of the target document. Yet another approach is to have users define style and formatting templates to be applied during text insertions. Creation of these templates can be time intensive and beyond the skill level of many users, who as previously mentioned often do not understand how formatting works in the first place; let alone understand how to create specific format mappings.

### BRIEF SUMMARY OF THE INVENTION

One aspect of the present invention can include a method, computer program product, system, and/or device for formatting content of an electronic document. This aspect can include identifying content of an electronic document and identifying a position of a target electronic document. In a formatting embodiment (e.g., where a selected portion of text is reformatted), the target electronic document and the document containing the identified content can be the same document. In an insertion embodiment (e.g., where a selected portion of text is to be inserted into a different document), the identified content can be contained in a source document, which is different from the target document. Format settings of pre-existing content of the target electronic document can be analyzed in a range about the identified position. Format settings can be determined for the pre-existing content in the range. At least one format scheme can be ascertained based upon the determined format settings. The ascertained format scheme can be applied to the identified content to generate a version of the identified content formatted in accordance with the determined format settings. The target electronic document can be changed so that the target electronic document includes the version (e.g., the reformatted version) of the identified content.

Another aspect of the present invention can include a system for formatting formatted content into a target document. The system can include a digital memory, a format analyzer, a normalization engine, and a content reformatting engine. The digital memory can store content to-be-reformatted. The format analyzer can detect format settings present in a target document about an identified position. The normalization engine can apply format settings detected by the format analyzer to determine a formatting scheme. The content reformatting engine can be configured to format the content-to-be-reformatted in accordance with a formatting scheme determined by the normalization engine. A placement of the reformatted content within the target electronic document can correspond to the identified position.

### BRIEF DESCRIPTION OF THE SEVERAL VIEWS OF THE DRAWINGS

FIG. 1 is a schematic diagram illustrating a system for automatically normalizing formatting of content to analyzed formatting of a target document in accordance with an embodiment of the inventive arrangements disclosed herein.

FIG. 2 is a schematic diagram illustrating a scenario for allowing a user to normalize formatting based on the formatting of the surrounding content at an insertion point (or selected region to-be-formatted) in accordance with an embodiment of the inventive arrangements disclosed herein.

FIG. 3 is a flow chart illustrating a method for formatting content to be inserted into a target document based on a determined prevalent formatting scheme in the target electronic document in accordance with an embodiment of the inventive arrangements disclosed herein.

FIG. 4 is a flow chart illustrating a method for re-formatting a selected portion of an electronic document responsive to a formatting operation in accordance with an embodiment of the inventive arrangements disclosed herein.

### DETAILED DESCRIPTION OF THE INVENTION

The present invention discloses a solution for handling formatting of an electronic document, such as when inserting content from a source document into a target document or when applying a format scheme to an existing region of an electronic document. The invention is premised on an assumption that a user generally desires content-to-be-formatted to conform to formatting conventions present in the target document. These formatting conventions, however, can be different from current formatting rules applicable at an insertion point or about a selected region of a document that is to be formatted.

For example, in an insertion context, the present invention, analyzes formatting present in the target document within a configurable range of a point of insertion. This range can include an entire target document or a limited portion of the target document, such as within one paragraph above the insertion point and two paragraphs below the insertion point. This analysis can result in a determination of a predominant format scheme of the target document for a region proximate to the insertion point. In one embodiment, when multiple format schemes are detected, a user can be prompted to select which of these format schemes is to be applied to the to-be-inserted content. This predominant format scheme and/or the user selected scheme can be applied to the content from the source document as it is added to the target document at the insertion point. An end result is that inserted content generally conforms closely in format to user expectations.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

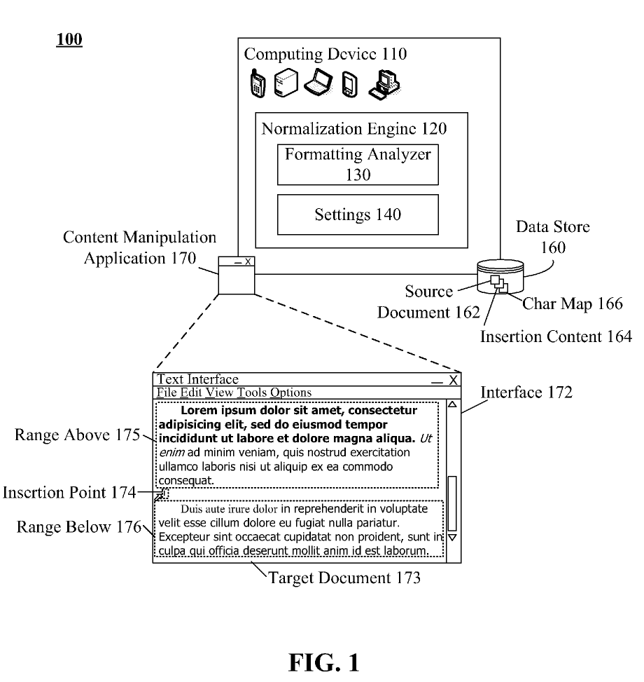

FIG. 1 is a schematic diagram illustrating a system 100 for automatically normalizing formatting of content 164 to analyzed formatting of a target document 173 in accordance with an embodiment of the inventive arrangements disclosed herein.

In system 100, a user of a computing device 110 can utilize a content manipulation application 170, which is able to open an instance of a target document 173 within a user interface 172. The content manipulation application 170 can permit content from at least one other document to be inserted into the target document 173. The content manipulation application 170 can also permit a region of a target document 173 to be selected, where this existing region is reformatted based upon analyzed formatting about the selected region.

In one embodiment, each electronic document from which content is extracted is called a source document 162, and the actual portion of content to be inserted into the target document 173 is called the insertion content 164. When the content 164 is inserted into the target document 173, formatting of the target document 173, as determined by normalization engine 120, can be applied to the newly inserted content 164. That is, a normalization engine 120 of device 110 is designed to “normalized” inserted content 164 to have a format of the target document 173.

In another embodiment, a selected portion of preexisting content of a single document can be considered an “insertion point 173.” This region of text is reformatted or normalized by engine 120 responsive to a formatting action, where normalization occurs based upon analyzed formatting of content proximate to the region. A formatting action can include, for example, an action occurring responsive to a user selection of a format painter control or other interface control designed to reformat a region of a selected document.

Effectively, a process of formatting a selected region of an electronic document (i.e., a formatting embodiment for system 100) or changing a format of content to be inserted in an electronic document (i.e., an editing or insertion embodiment for system 100) is programmatically equivalent from the perspective of the normalization engine 120. For simplicity of expression, specific references shall be targeted at an insertion embodiment hereafter. It shall be understood, however, that these examples are also applicable to a formatting embodiment. That is, specifics provided regarding an insertion embodiment are for illustrative purposes only and are not to be construed as an attempt to exclude a formatting embodiment of the invention in any manner. References to a target document 173 or a source document 162 made in an insertion embodiment translate into a non-selected region (approximately equivalent to target document 173) of a selected to-be-reformatted-region (approximately equivalent to source document 162) when applied to the formatting embodiment.

The normalization engine 120 can use a formatting analyzer 130 to determine one or more formatting schemes of the target document 173. In one configuration, the analyzer 130 can determine a predominant format of the target document 173 and apply it to the content 164 during insertion. The predominant format can be different from a format scheme in place at the insertion point 174, which is by default applied to newly entered text. For example, a range above 175 the insertion point and/or a range below 176 the insertion point 174 can be defined and the formatting scheme can be determined by analyzing a most utilized format within the ranges 175, 176. The configurable settings 140 can prefer one range 175, 176 over the other range 175, 176 during this determination. Further, the defined range 175, 176 for analysis can include the entire target document 173.

In one embodiment, when multiple formatting schemes are identified as possible ones to be applied to content 164, a user can be prompted to select among these different formatting schemes. Any number of thresholds and likelihood values can be utilized by the analyzer 130 to programmatically determine which options of formatting schemes are to be presented to a user for selection. For example, the analyzer 130 can determine a likelihood value of the multiple formatting schemes and can present the top N number of schemes to a user for selection. In another example, the normalization engine 120 can present a formatting scheme as an option only if it has a likelihood value of greater than some predetermined value M. In still another example, whenever a top formatting scheme has a sufficiently high likelihood value it is used automatically without prompting, but when a different formatting scheme is almost as likely as a top scheme, a formatting selection pop-up can be presented within interface 172. Behavior of analyzer 130 can be adjusted for preferences of a user and/or an application 170 using settings 140, which can optionally be configured using interface 172.

Additional considerations can be utilized by the formatting analyzer 130 as factors when determining a formatting scheme to be applied to the insertion content 164. For example, formatting of the source document 162 compared to the formatting of the target document 173 can be a factor, past insertion operations and format selections/schemes related to the document 173 and applied during those operations can be a factor, a user profile of preferred formatting schemes can be a factor, values of configurable settings 140 can be a factor, settings specific to a content manipulation application 170 can be a factor, etc. Generally, the formatting analyzer 130 can utilize any set of deterministic algorithms of arbitrary complexity ranging from simple to highly complex, so long as formatting considerations of text to be inserted is based at least in part upon an analysis of formatting present in a region (and not just default formatting established at an insertion point 174) of the target document 173.

As used herein, the content manipulation application 170 can include any application within which content formatting or insertion operations can be performed. A content insertion operation can refer to an insertion from a clipboard memory (e.g., a cut-and-paste or a copy-and-paste operation) or to a document merge operation (e.g., mail merge, compare and merge documents, etc.). A formatting operation can refer to a programmatic operation that changes a format of a selected region of an electronic document. The content manipulation application 170 can include a local, served, or Web based application. In various arrangements, the application 170 can include a word processing application, a spreadsheet, a presentation application, a publishing application, a media authoring application, a software development application, and the like.

The source 162 and target documents 173 can be any type of electronic document or portions thereof. For example, documents 162, 173 can be word processing documents, markup based document, Cascading Style Sheets (CSS) formatted documents, media files, presentation documents, publication documents, spreadsheets, and the like. Typically the documents 162, 173 will include formatted text as well as numerous other optional elements, such as graphics.

The insertion content 164 can represent a small portion of the source document or the source document 162 in its entirety. Original formatting of a source document 162 can be retained when the content 164 is stored in memory 160, or can be removed before storage depending upon implementation. In a formatting embodiment, the insertion content 164 can represent a portion of a selected document as originally formatted before a formatting operation is performed.

Formatting schemes and formatting detected and applied by analyzer 130 can include character based formatting (e.g., font size, font color, font type, font style—italic, bold, underline, etc.), sentence based formatting (e.g., line spacing, line width, spaces expected before a period, etc), section based formatting (e.g., tab spacing, paragraph spacing, bullet types and indentation rules, etc.), page based formatting (e.g., footer, header, page numbing), document based (page numbering, watermarks, background color/style, etc.), control based (e.g., line width, fill properties, text spacing properties about a text box or graphic, a number of columns and column width for a table, etc.), and the like. Exact formatting options for an instance of the invention can vary by document 162, 173 type and application 170 type. Most implementations will permit, at a minimum, basic formatting options to be applied against text, such as typeface, font, font size, font color, and the like.

Computing device 110 can be any of a variety of devices capable of presenting interface 172 to a user. For example, the computing device 110 can be a desktop computer, a notebook computer, a personal data assistant (PDA), a smart phone, an e-book reader, a thin client, a gaming platform, a kiosk, and the like.

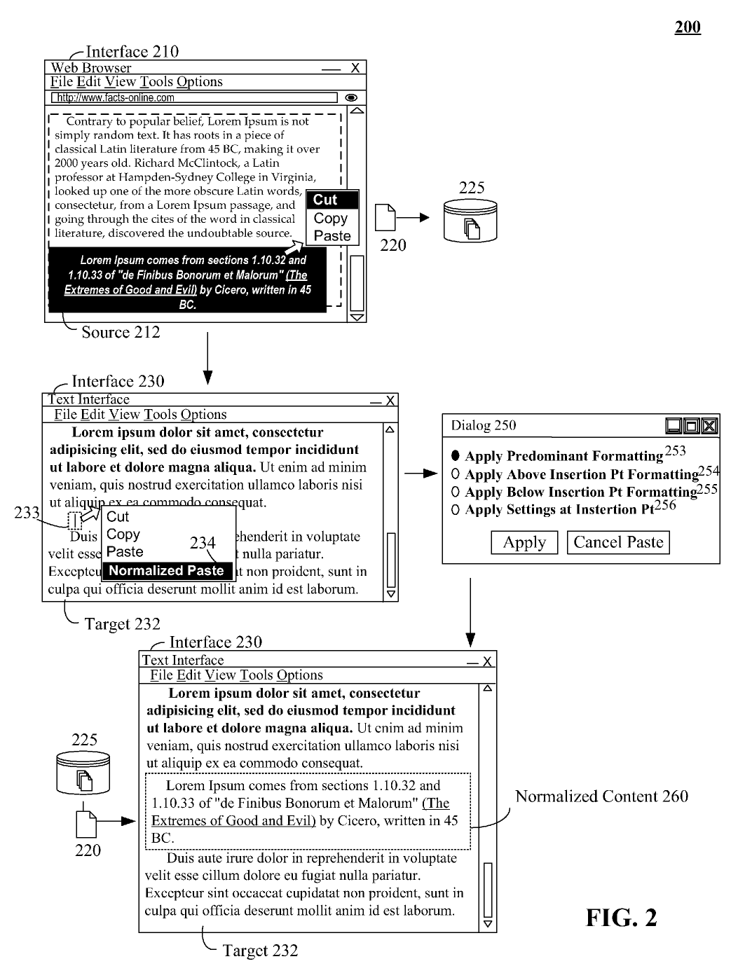

FIG. 2 is a schematic diagram illustrating a scenario 200 for allowing a user to normalize formatting based on the formatting of the surrounding content at an insertion point (or selected region to-be-formatted) in accordance with an embodiment of the inventive arrangements disclosed herein. The scenario 200 can utilize system 100 or any system capable of manipulating formatting of a portion of an electronic document. The scenario 200 specifically applies to a cut/copy/paste embodiment. The invention is not to be limited in this regard, however. The invention can, for example, can be applied to document merging operations and to formatting operations. Additionally, the details in the GUIs shown in scenario 200 are shown to illustrate a concept and not are not to be construed as interface or implementation limitations.

In scenario 200, a clipboard operation can be performed against a portion of a source 212 document shown in user interface 210. The illustrated clipboard operation is a copy operation, which places content 220 in a clipboard memory 225. A cut operation can have a similar result of placing content in the memory 225.

A different clipboard operation can be performed by a user of text interface 230. This different clipboard operation can cause the previously stored content 220 to be added to the target document 232 at an insertion point 233. In one embodiment, the clipboard operation performed in interface 230 can be a special “paste” command, such as a normalized paste 234. Selection of the normalized paste 234 can result in an analysis of target document 232 to determine a “predominant format” of the document 232.

Different definitions can be established for determining this predominant format. In one embodiment, a user can be presented with a pop-up 250 or other prompt. This pop-up 250 can present multiple different options for normalizing the content to be inserted to the formatting of the target document 232. For example, one option 253 can be to apply a predominant formatting of the entire target document to the inserted content 222. Another option 254 can be to apply a format of a paragraph above the insertion point 233 (assuming that format is different from the predominant format of the target document 232 as a whole as determined by a formatting analyzer). Still another option 255 can be to apply a format of the paragraph below the insertion point 233 (assuming this is a unique format). Yet another option 256 can be to apply a “current” formatting present for new text entered at the insertion point 233. Once a user selects an option 253-256, the associated formatting is applied to the clipboard content 220, which is inserted into the target document 232 as content 260 having normalized formatting.

In one embodiment, presentation of popup 250 can be situational. For example, when all of the options 253-256 have equivalent formatting, the pop-up 250 may not appear. In another example, the popup 250 will not appear when a likelihood of a desired format scheme (a top formatting scheme) is considerably greater than a likelihood of a next topmost formatting scheme determined from analyzing the target document 2xx. The options 253-256 and the analysis rules for determining the targeting formatting can be configurable, such as in a user-specific and/or application specific manner.

In another embodiment, the formatting applied to the content to be inserted 220 need not be uniform. For example, a format analyzer can identify multiple different sections of content in the content to be inserted 220 and can determine approximately equivalent sections within target document 232. The formatting applied to each section of the content to be inserted 220 can be based upon a format of the equivalent section present in target document 232.

In one embodiment, a formatting of the source 212 can be levered by a format analyzer when determining the normalized formatting 250. For example, section breaks for formatting purposes present in the copied portion of source 212 can be considered when determining what section of the target document 232 should be analyzed to determine a formatting for a similar section. When the formatting of the source 212 is a factor used by format analyzer, a mapping of special characters can be utilized. That is, a mapping between GUI 210 special characters (which can be in XML) and special characters of the text interface 230 (which can be a document proprietary format, such as RTF) can be used to facilitate the normalization of formatting, especially when complex formatting operations are performed, such as section based formatting, paragraph based formatting, page based formatting, control based formatting, etc.). Special character mappings from any standardized format can be made to any other standardized format (i.e., document format converters for a myriad of different document types exist and use well known technologies involving special character mappings to convert from one document type to another). Even in an embodiment where source 212 formatting is considered and/or utilized, it is the formatting present in the target document 232 that determines a format scheme to be applied to the content to be inserted 220. The formatting of the source document 212 is optionally used to improve an accuracy of this target based format normalizing.

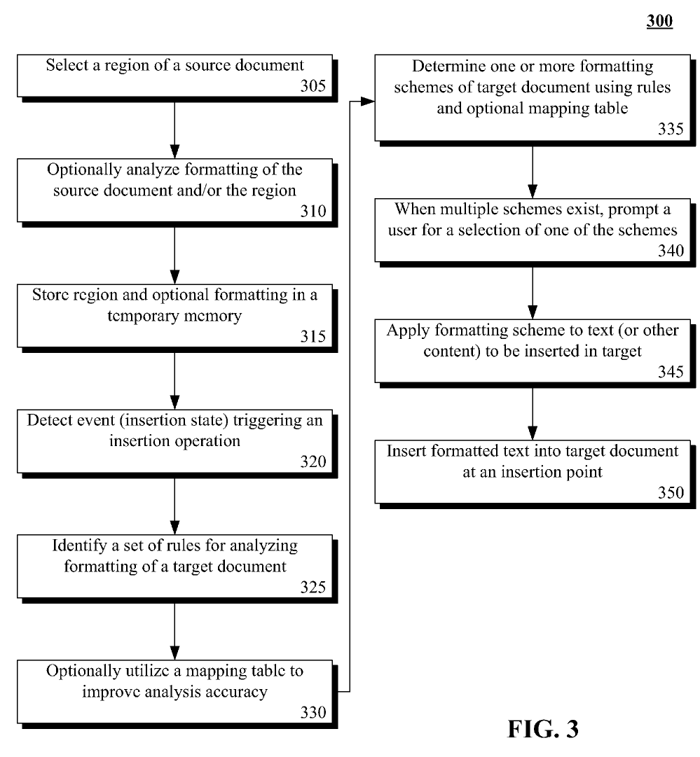

FIG. 3 is a flow chart illustrating a method 300 for formatting content to be inserted into a target document based on a determined prevalent formatting scheme in the target electronic document in accordance with an embodiment of the inventive arrangements disclosed herein. Method 300 can be performed in the context of system 100 or any other system capable of adding content from a source document to a target document. Method 300 is focused upon an insertion and reformatting of text. The invention is not, however, to be limited to text formats and can apply to any digital content having an associated formatting scheme.

Method 300 can begin in step 305, where a region of source text is selected to be added to a different electronic document, referred to as a target document. Source text can be manually selected by a user or can be automatically selected by a “compare and merge” or other document merging program. In optional step 310, if the formatting of the source is to be considered during a text normalization operation, the formatting of the source text can be analyzed and/or the formatting of the selected region of text can be analyzed. An attempt to analyze the selected region may require a knowledge of special characters outside the selected region, such as document specific settings, which can be extracted and analyzed in step 310. Formatting considerations applicable for a normalization operation can be annotated for the selected region, such as within meta-data of the selected region or in a region specific file or set of parameters. In step 315, the region and any optional formatting about the source region can be stored in a temporary memory, such as a clipboard memory.

In step 320, an insertion state for inserting the selected region into a target region can be detected. The insertion state can be a state programmatically triggered by a user command (e.g., a paste operation or a normalized paste operation) or by a programmatic action (e.g., part of a merge document function). In step 325, a set of rules to be used when analyzing a formatting of the target document can be identified. These can be a set of default rules or can be a set of user-specific, application specific, and/or situation specific rules to be applied to the insertion operation. In step 330, a mapping table can be optionally used, which maps special characters present in the source document to equivalent special characters in the target document. The mapping table can be used in conjunction with the formatting extracted from the source document to improve accuracy of format normalization based upon formatting of the target document in one implementation of the invention. In step 335, the formatting rules and optional mapping tables and source formatting can be used to determine one or more formatting schemes present in the target document, which are to be applied to the selected region.

When multiple different formatting schemes are possible, a user can be prompted to select one of them that is to be applied, as shown by step 340. In step 345, an automatically determined or user selected (from the prompting of step 340) formatting scheme can be applied to the text to be inserted. In step 350, the formatted next can be inserted in an insertion point of the target document. The steps of method 300 can be repeated for each incongruous segment of text (or other content) that is to be inserted from the source document to the target document (i.e., the steps can repeat for different insertion points in the target document, especially when an analysis of the target formatting is specific to the insertion point).

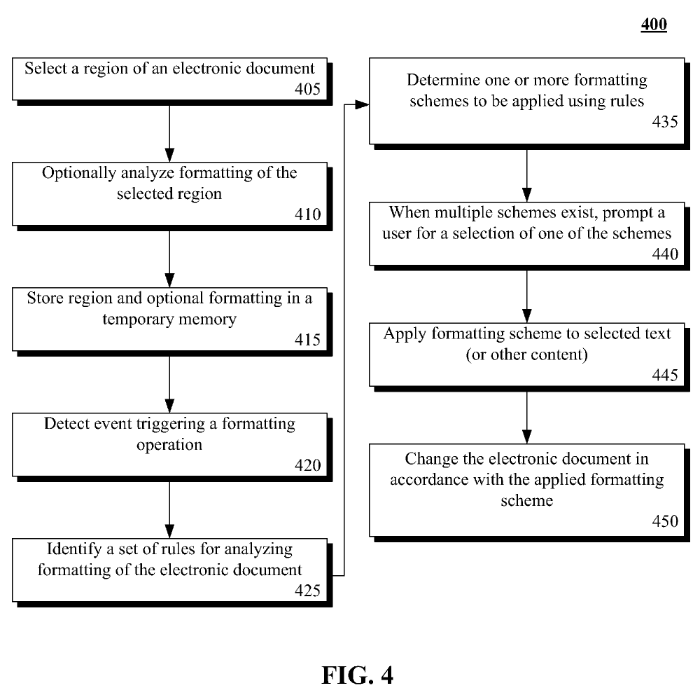

FIG. 4 is a flow chart illustrating a method 400 for re-formatting a selected portion of an electronic document responsive to a formatting operation in accordance with an embodiment of the inventive arrangements disclosed herein. Method 400 can be performed in the context of system 100 or any other system capable of reformatting content of an electronic document. Method 400 is focused upon a reformatting of text. The invention is not, however, to be limited to text formats and can apply to any digital content having an associated formatting scheme.

Method 400 can begin in step 405 when a region of an electronic document can be selected. For example, a user can use a pointing device to highlight a portion of an electronic document. In step 410, the selected portion can be optionally analyzed to determine its formatting. This option is only necessary when a formatting scheme to be applied when reformatting the selected region varies based upon formatting specifics of the content region being modified. The region and the optional formatting can be stored in a temporary memory, such as a RAM. In one embodiment, this temporary memory can be used to restore a region (e.g., a user undo command is selected) to an original formatting should a user desire to revoke a formatting operation applied to it.

In step 420, an event triggering a formatting operation (e.g., selection of a format painter control, a format menu option, a hot-key combination associated with reformatting a region, etc.) can be detected. In step 425, a set of rules for analyzing formatting of the electronic document can be identified. These rules can include user configurable settings. In step 435, one or more formatting schemes to be applied can be determined from these rules. Each of these formatting schemes can be based upon formatting present in portion of the electronic document about the selected region. That is, unlike a tradition “format painter” operation that requires a user to select a region having a desired format that is to be applied to a different region, method 400 determines the desired formatting based upon an automatic analysis of content regions about the region-to-be formatted. When multiple schemes exist, a user can be prompted to select one of them, as shown by step 440. In step 445, a formatting scheme can be applied to the selected region, thus reformatting text and other content of the reselected region. In step 450, the electronic document can be changed to reflect the applied formatting scheme. For example, a document visually presented in a WYSIWYG graphical user interface (GUI) can show the newly applied formatting scheme.

The diagrams in FIGS. 1-4 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for formatting content of an electronic document comprising:
identifying content of an electronic document;
identifying a position of a target electronic document;
analyzing format settings of pre-existing content of the target electronic document in a range about the identified position;
determining format settings for the pre-existing content in the range;
ascertaining at least one format scheme based upon the determined format settings;
applying the ascertained format scheme to the identified content to generate a version of the identified content formatted in accordance with the determined format settings; and
changing the target electronic document so that the target electronic document comprises the version of the identified content to which the format scheme has been applied, wherein a placement of the version of the identified content within the target electronic document corresponds to the identified position.

2. The method of claim 1, wherein said electronic document is a source document different from said source document, wherein said identified position is an insertion point at which content from the source document is to be inserted into the target document, said changing step comprising:
adding the version of the identified content to the target document at the insertion point.

3. The method of claim 2, further comprising:
initiating at least one of a cut and copy operation to place a copy of a delineated potion of the source document in a clipboard memory, wherein said delineated potion is the identified content; and
initiating a paste operation at the insertion point, which ultimately results in the version of the content being added to the target document at the insertion point.

4. The method of claim 3, wherein the paste operation is a specialized version of a paste operation existing as a user selectable option for performing pasting actions involving the clipboard memory, wherein other user selectable options for performing pasting actions exist.

5. The method of claim 2, further comprising:
detecting a request to merge content of a source document with content of the target document;
responsive to the detected request, automatically establishing a location of the insertion point in the target document; and
identifying all content of the source document as the identified content.

6. The method of claim 2, wherein the source document is a Web document presented within a browser, wherein the identified content is a portion of the Web document selected by a user, and wherein the target document is a word processing document presented within a word processing application.

7. The method of claim 2, wherein said source document and said target document are two different types of documents utilizing different standards for special characters, which define a formatting of content, said method further comprising:
determining a mapping of special characters from a standard of the source document to a standard of the target document, and
utilizing the determined mapping to either establish the format scheme that is applied or to create the version during the applying of the format scheme.

8. The method of claim 1, wherein said electronic document is said target electronic document, wherein said identified content is a user selected region of the target electronic document, wherein said identified position corresponds to said user selected region.

9. The method of claim 1, wherein the identified content and the version comprise formatted text, wherein the format settings are text format settings specified by a plurality of special characters.

10. The method of claim 1, wherein the at least one ascertained format scheme comprises a plurality of different format schemes, said method further comprising:
prompting for a selection of one of the plurality of different format schemes; and
receiving the selection, establishing the selected one of the plurality of different format schemes as the format scheme applied to the identified content to generate the version.

11. The method of claim 1, wherein said range is a user definable range.

12. A system for adding formatted content to a target document comprising:
a digital memory configured to store content to-be-reformatted;
a format analyzer configured to detect format settings present in a target document about an identified position;
a normalization engine configured to apply format settings detected by the format analyzer to determine a formatting scheme; and
a content reformatting engine configured to format the content-to-be-reformatted, in accordance with the formatting scheme determined by the normalization engine, and wherein a placement of the reformatted content within the target electronic document corresponds to the identified position.

13. The system of claim 12, further comprising:
a data store comprising a plurality of user configurable settings, wherein said user configurable settings define a range about the identified position used by the format analyzer when detecting the format settings.

14. The system of claim 12, wherein the stored content and the content inserted in the target document comprises formatted text, wherein the format settings detected by the format analyzer and applied by the normalization engine comprise text format settings specified by a plurality of special characters.

15. The system of claim 12, wherein the digital memory is a clipboard memory, said system further comprising:
a clipboard operation engine configured to perform cut, copy, paste, and normalized paste operations, wherein said format analyzer and said normalization engine are utilized during an execution of the normalized paste operations and are not utilized during an execution of the paste operation.

16. The system of claim 12, further comprising:
a merge document engine configured to merge content from at least two different documents, which comprise the source document and the target document, wherein said merge document utilizes the format analyzer, the normalization engine, and the content insertion engine when merging content to format content extracted from the source document to format settings detected within the target document.

17. The system of claim 12, further comprising:
a prompting interface configured to prompt a user to select from among a plurality of possible formatting options determined by the format analyzer, wherein a user selected option from the prompting interface determines the format settings used by the normalization engine.

18. A computer program product for formatting content of an electronic document, the computer program product comprising:
a computer usable medium having computer usable program code embodied therewith, the computer usable program code comprising:
computer usable program code configured to identify content of an electronic document;
computer usable program code configured to identify a position of a target electronic document;
computer usable program code configured to analyze format settings of pre-existing content of the target electronic document in a range about the identified position;
computer usable program code configured to determine format settings for the pre-existing content in the range;
computer usable program code configured to ascertain at least one format scheme based upon the determined format settings;
computer usable program code configured to apply the ascertained format scheme to the identified content to generate a version of the identified content formatted in accordance with the determined format settings; and
computer usable program code configured to change the target electronic document so that the target electronic document comprises the version of the identified content to which the format scheme has been applied, wherein a placement of the version of the identified content within the target electronic document corresponds to the identified position.

19. The computer program product of claim 18, wherein said electronic document is a source document different from said source document, wherein said identified position is an insertion point at which content from the source document is to be inserted into the target document, said computer program product further comprising:
computer usable program code configured to add the version of the identified content to the target document at the insertion point.

20. The computer program product of claim 18, wherein said electronic document is said target electronic document, wherein said identified content is a user selected region of the target electronic document, wherein said identified position corresponds to said user selected region.
